(19) United States
(12) Patent Application Publication
(10) Pub. No.: US 2009/0086015 A1
(43) Pub. Date: Apr. 2, 2009

(54) SITUATIONAL AWARENESS OBSERVATION APPARATUS

(75) Inventors: Jan Ove Larsen, Lillestrom (NO); Aslak Jarle Lien, Kjeller (NO); Magne Lorentsen, Frogner (NO); Roar Johnsen, Fjerdingby (NO); Halgeir Fuglstad, Nordby (NO); Magne Norland, Skedsmokorset (NO)

Correspondence Address: YOUNG & THOMPSON, 209 Madison Street, Suite 500, ALEXANDRIA, VA, 22314, US

(73) Assignee: KONGSBERG DEFENCE & AEROSPACE AS, KONGSBERG (NO)

(21) Appl. No.: 12/183,450

(22) Filed: Jul. 31, 2008

Related U.S. Application Data
(60) Provisional application No. 60/952,922, filed on Jul. 31, 2007.

(30) Foreign Application Priority Data
Jul. 31, 2007 (NO) 20073983

(51) Int. Cl. H04N 15/00; H04N 7/18

(52) U.S. Cl. 348/46; 348/143; 348/158; 348/148; 348/E07.085

(57) ABSTRACT

A positionable sensor assembly for a real-time remote situation awareness apparatus includes a camera for capturing an image of a scene, a plurality of first acoustic transducers for capturing an audio input signal from an environment including the scene, at least one second acoustic transducer excitable to emit an audio output signal, a support structure for supporting the camera, the plurality of first acoustic transducers and the at least one second acoustic transducer, the support structure connected to a base, moveably at least about an axis of rotation relative to the base by a remote controllable support structure positioning actuator, and a transmission unit adapted to transfer in real-time between the transducer assembly and a remote location a captured image of the scene, a captured audio input signal from the environment, an excitation signal to the second acoustic transducer, and a control signal to the support structure positioning actuator. A positionable sensor assembly for a real-time remote situation awareness apparatus. The sensor assembly comprises a camera arranged to capture an image of a scene, a plurality of first acoustic transducers adapted to capture an audio input signal from an environment comprising said scene, at least one second acoustic transducer excitable to emit an audio output signal, a support structure arranged to support said camera, said plurality of first acoustic transducers and said at least one second acoustic transducer, said support structure connected to a base, moveably at least about an axis of rotation relative to said base by a support structure positioning actuator controllable from a remote location, and a transmission means adapted to transfer in real-time between said transducer assembly and said remote location a captured image of said scene, a captured audio input signal from said environment, an excitation signal to said second acoustic transducer, and a control signal to said support structure positioning actuator.

Known remotely operated weapon stations, herein referred to by the acronym RWS (an acronym for “Remote Weapon Station”), exhibits impressing system functions and system properties, but generally are also having certain shortcomings when it comes to surveillance of the areas that closely surround the platforms of the remote weapon stations they are mounted on.

As an example, do those who are located inside a clearing vehicle known under the name (“Stryker”) (Stryker Light Armoured Vehicle III [LAV III]) experience, that when the hatch is closed, is there almost a total lack of view to the surrounding world. Remote weapon stations mounted on the Stryker vehicle are equipped with good cameras that are part of the RWS aiming device, but they are developed to meet demands placed on the system for long distance observations. The final result is a relatively narrow field of view, also when applying minimum zoom. The limited rate of rotation of the RWS thus also contributes to a feeling that the situational awareness should be better.

By experience, the RWS-system is in practice mostly used in cities and urban areas. Such scenarios are characterized by that “everything” of interest is closer than approximately 450 ft. Objects being that close give rise to a need for rapid rotation of the RWS relative to the vehicle, due to the movements of the vehicle or the movements of the target.

This disclosure describes a supplementary sensor system intended to compensate for the lack of windows in the Stryker vehicle, and inherent limitations of the RWS. The system has capabilities to give the operator a feeling of “to be there”, outside the vehicle.

A system having the capabilities need to “be there”, in a different place than the actual location of the operator, is contemplated also to be used in other scenarios:
Near observation of marine vessels, without having guards deployed. The surveillance may be made from a centralized watch room.
Supervision of stationary, land based facilities over large distances. In such places, sensor arrangements are contemplated deployed in several locations and operated from a centralized site.
Applications where the distance between the sensor head and the operator is very large are also considered. It is made possible to make surveillance of objects in other parts of the country or on the other side of the globe, provided that there is available a broad band internet connection there between.
As an example of an extreme application, it is also contemplated that such a system is used to communicate with people in other places, such as e.g. in connection with repairs of maintenance of complicated products, such as complicated optical, mechanical or electronic parts in e.g. aircrafts, weapon systems or offshore installations.
Use in connection with remote assistance in complicated surgical procedures.

The market for civil applications is considered to be large, and limited only by the human imagination. In the next chapter, the proposed system is described in further detail.

The idea is simply to make a small, light weight sensor head of the size of a human head that may be operated by a remotely located operator.

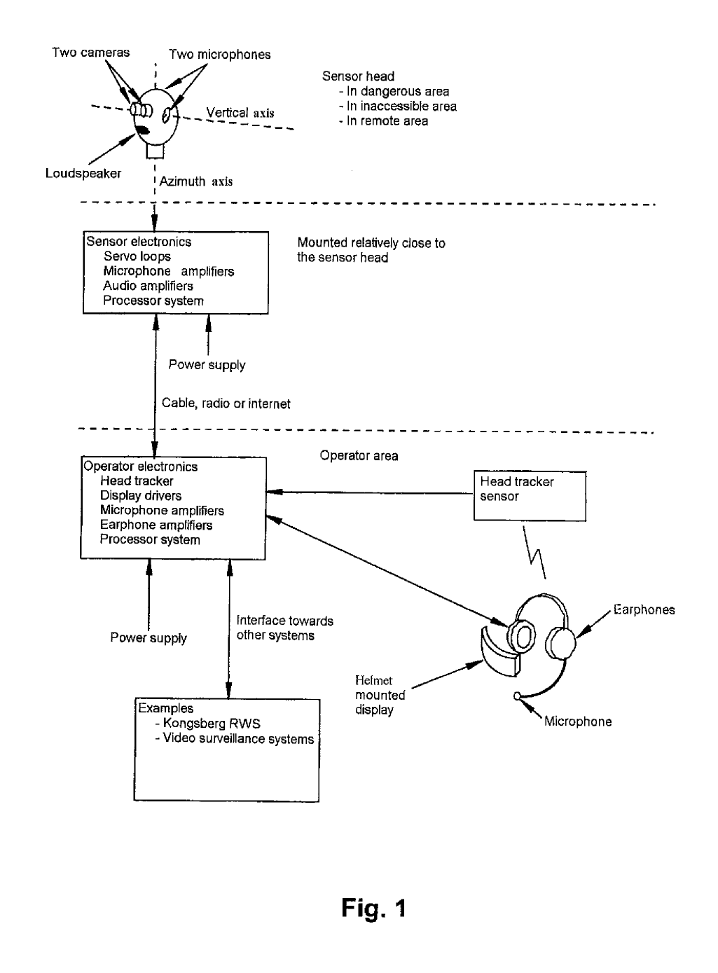

The following description is based on a simple system example, to describe the idea of the invention and possible embodiments, and are illustrated in general terms the enclosed FIG. 1.

The sensor head should preferably include two cameras for stereoscopic vision, two microphones for sound reception to allow stereophonic reproduction of sound, and a loudspeaker to communicate with humans in the surroundings of the sensor head.

The operator carries a helmet, preferably with a stereoscopic display in front of the eyes, headphones for reproduction of stereophonic sound, and microphone to communicate with persons in the vicinity of the sensor head.

The system is provided with outputs and inputs to be connected to other system to cooperate with those. As an example, it is contemplated that the operator of the proposed surveillance system discovers something interesting outside the vehicle (in case of the combat vehicle “STRYKER”). It is contemplated a function where the person in a dialog with the operator of the RWS automatically commands the RWS to point in the same direction as the observation system. This will represent a very efficient way to hand over targets.

The proposed observation system will comprise the elements shown in FIG. 1.

It is an important part of the concept that the sensor head is provided with very rapid systems for rotation of the “neck” and for tilting of the sensor head in elevation. These servo systems should have a dynamic capability as fast as the muscle arrangement in the human neck. The idea is that these two servo axis are to be slaved to the neck movements of the operator by way of a sensor system that measures the head movements of the operator, such as e.g. rotations of the head.

The net effect to be experienced by the operator is that the operator “is present” with vision, hearing and conservation capabilities. The microphones placed on the sensor head in ear positions and in artificial ears/ear canals give a surprisingly good capability for determining the direction of sound.

Thereby, sound may be used as a warning, whereupon the operator will be prompted to turn his head in the direction of the sound to listen for, and look for the source.

In a stereophonic embodiment providing tracking capabilities in azimuth directions as well as in elevation, the sensor head is provided with two cameras, two microphones, at least one loudspeaker, two motors for positioning and two angle measuring devices for measuring position. For military applications the mechanical solution must be designed to withstand a harsh environment, while for civil applications it is contemplated to build the solution at a lower cost and substantially simpler.

An electronics unit is contemplated arranged in vicinity of the sensor head, with external interface, power supply input, as well as coupling to the sensor head and its components mentioned above.

Particularly, with regard to camera, it is taken into consideration that the human vision is special in that it is generally considered to be very good, in the sense that it has a high resolution, while the field of vision is very large. However, the human vision has its greatest resolution only in a very small sector centrally located in the field of view. These properties lead to the observation system preferably must be providing a reasonable large field of view in combination with a reasonable resolution.

For good functionality in the realisation of the invention, it may prove important to determine a composition of properties with regard to cameras. In addition to a suitable field of view and resolution, cameras are preferably to provide a resolution in a frame rate that is 20 Hz or higher. Ordinary video with a resolution of 640×480 (US) or 768×525 (EUR) may for the intended area of application of the present invention be too limiting with regard to resolution and field of view. An acceptable resolution will, however, generally imply that the field of view becomes small. The human vision has generally a resolution of 0.2 mrad. It is therefore considerably important that the field of view of the cameras and the field of view of the helmet mounted display are equally large to provide a natural feeling of presence and judgement of distance. Of the same reasons, the cameras should be positioned with a mutual spacing that is about the average distance between the eyes of human beings.

In order for the cameras to provide the maximum resolution of the vision with standard video, the horizontal field of view becomes around 153 mrad, which corresponds to 8.8 degrees. As experienced, this will give an operator the feeling of “looking out through a drinking straw”. Cameras existing today provide a resolution of 1280×1024, and with a is frame rate that is considered to be acceptable, as indicated above. A suitable choice of camera properties may be the aforementioned camera rate and optics, to provide a resolution of 0.5 mrad, which is less than half the resolution of a normal vision of a human. This embodiment will give a horizontal field of view of:

1280×0.5=640 mrad=36.7 degrees.

The diagonal field angle will then correspond to approximately 44 degrees. This resolution corresponds to a resolution of 2″ on 300 ft., and is considered good enough to be able to see if the human at a distance of 300 ft. from the sensor is holding a hand weapon. The resolution in this way will be 0.02″ at a distance of 3 ft., meaning that it will be possible to read printed text slightly larger than a normal type at the aforementioned distance.

The requirements for control of focusing and whether it shall be manual or automatic must be considered.

The cameras are preferably adapted to render colours.

The system is preferably designed as much as possible like a human head, and with ear like protrusions for locating microphones, which is considered important to achieve the ability to determine direction. It is contemplated to produce an embodiment of the invention with an artificial head microphone system KU100 from the German manufacturer Georg Neumann GmbH. It is contemplated to achieve a useful function with a shape of an artificial head that deviates more from the typical shape of the head of a human. The microphones should have a combination of good sensitivity and tolerance for high sound levels without leading to noticeable distortion of the captured sound signal.

The loud speaker is considered to be less critical part of the system, meaning that there is a larger room for selecting properties. It is contemplated that for a low cost embodiment a small full tone loud speaker having a membrane diameter of between 2″ and 4″, which is adapted to produce a sound level adequate in the frequency area for normal speech to exceed the level of noise produced by the vehicle.

To achieve large dynamic range in several systems, direct drive is considered advantageous, such as e.g. by having the motor connected directly to the load without any gear arrangement. For an embodiment of the present invention, it is contemplated to use two each of “span cake” moment motors, one for each direction of rotation, i.e. azimuth and elevation, respectively. These motors may be brush motors or brushless motors. Brushless motors can be driven by the RWS amplifiers, while brush motors may simply be driven by linear amplifiers.

The simplest element for measuring angles is a low cost potential meter. The low cost potential meter may advantageously be used in the vertical joint. In the azimuth joint the low cost potential meter represents a limitation as is does not cover continuously 360° in a way that is considered to be satisfactory for the contemplated main application. An embodiment in which there are not imposed strong requirements for a stepless and continuous trucking capability, such as e.g. where it is acceptable with a limitation for the system to track within 270° in the azimuth, the embodiment is made within the limitations that typically are imposed by low cost potential meters.

The sensor electronics is contemplated with the following main elements:
electronics for receiving data from the cameras
microphone amplifier and AD-converter for the signals from “the ears”
audio amplifier for driving the loud speaker
servo electronics for slaving the two mechanical axis to angular data from the main electronics
a processor system for overall control and communication with the operator electronics.

In an operative system, i.e. when the invention is operational, the definition of the interface towards the operator electronics is considered important. It will, among other things, be necessary with a real time compression of image data from the cameras, particularly if the interface is to be a radio or internet interface. For a test systems that embodies the invention, the servo, audio and video may in a simple solution be connected by separate cables.

In the following an operating unit for the observation solution of the invention is described.

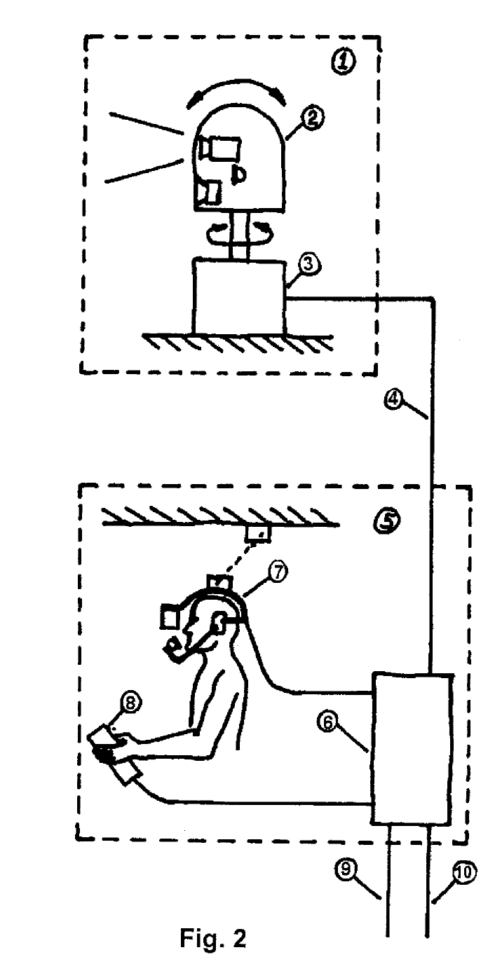

In an embodiment example as illustrated in FIG. 2, where the embodiment example is shown, is here explained with the following reference numbers and the following designation in English:

“” A Remote location 1, at which is located Sensor assembly 2 comprising a moving part in turn comprising Servo axis, at least two, Cameras, typically two for stereoscopic imaging, Microphones, typically two for stereophonic/binaural sound, Loudspeaker, at least one for operators voice, Sensor assembly 3, comprising stationary part, in turn comprising at least a Mechanical interface to movable part (2), an Electrical interface to all units in movable part (2), and a Communication equipment for sending and receiving data with, a processing unit 6 at an operator location, Means 4 of communication (cable, radio, internet . . . ), an Operator location 5, at which is located a Processing unit 6 at the operator location, comprising: a Communication equipment for sending and receiving data with (3), an Electrical interface to all units in head mounted unit (7), an Electrical interface to operator panel (8), Audio amplifiers, Video system for displaying camera video on head mounted display, Servo electronics/software for controlling sensor assembly orientation, Processing resources for control of system operation, a Head mounted unit 7 comprising: a Head tracker to measure operators head orientation, a Display, stereoscopic, Headphones, stereophonic to present binaural audio, a Microphone for picking up operators voice, and, a Operator panel 8, an Electrical power input 9, and a Communication interface 10 for interacting with other system (e.g. RWS).

Note that some parts of item 6 could be instead be located with item 3.”

The operator display is advantageously stereoscopic, meaning that it has independent displays, one for each eye. The displays are of a type where may not look through in addition to what is displayed on the displays. In a operational system it is considered to be advantageous to use a display that may change between transparent/not. This can possibly be resolved by mechanically tilting up the display.

The displays are contemplated to have a resolution that corresponds to the resolution of the cameras used, which is to mean that the resolution corresponds to the advantageous camera resolution indicated above. For a system suggested over, displays having a resolution capability of 1280×1024 pixels or better should be used. The optics of the display is also contemplated to be such that the field of view is as large as possible 1:1 with the field of view of the cameras, meaning that a desired horizontal field of view becomes 36 degrees, which corresponds to diagonal field of view of 44 degrees.

Preferably displays are rendering colours.

The headset of the operator is preferably of a closed type headset with a function for noise cancellation. This means that a headset which actively attenuates noises in the area closely surrounding the operator (inside the vehicle in case of a STRYKER). Such headsets are provided by several vendors for use in among other airplanes (such as e.g. Bose).

The microphones of the operator is contemplated to be of the same noise cancellation type as used in aircrafts. A simple and low cost solution is contemplated, where use is made of a complete noise cancelling “headset” for aircraft for a combined earphone and microphone.

A wide range of different technologies exists that may be useful for measuring the head rotations of an operator for use for a head tracker. Such solutions may be based on optics, magnetic field and/or inertial sensors, or other technology. The choice of a well known technology, or development of new or an adaptation of existing technology, may be influenced by the demands to the performance and demands to costs. It is contemplated to make use of one basically known technology for measuring the head rotations of an operator for use for a head tracker in a low cost embodiment of the present invention.

The operator electronics is preferably a processor system that has overall control of the system. It will read the head angles by using the head tracker sensor and send servo commands to the sensor electronics.

Video between what is provided by the cameras and what is to be provided to the displays is considered reformatted. This is contemplated done by use of a FPGA.

As indicated above, it is contemplated that the invention is embodied using a camera that is positionable around two axis, an azimuth axis and a elevational axis, respectively. In a practical use with the sensor arranged on a vehicle which is moving about in a sloped terrain, it is contemplated to add to the sensor device of the invention a device for roll axis positioning. This would typically mean a roll axis positioning a control of the camera about a roll axis.

According to the present invention, it is, however, contemplated to provide roll axis positioning without mechanical means, with an electronic processing of the image from the camera where the image is subject to a redrawing of the image on one or more of the displays that are located in the field of the view of the operator, after a geometrical rearrangement of the image elements. As an example, the geometric rearrangement of the image elements may correspond to a rotation that is recorded by a roll sensor in the head tracker part of the system. The solution suggested by the present invention is a head tracker or head follower, that senses the head angle of the operator, meaning the angle which in fact exists by the operator in a natural way leaning his head to the right or to the left relative to his own axis of view for locating his own field of new of view plane in correspondence with the natural plane, or of horizon, of the scene being observed. The technical solution suggested by the present invention comprises a sensor adapted to sense the angle represented by the head roll movements of the operator, reference to a reference plane that is stationary with respect to the aircraft, such as e.g. could be the natural floor plane of the vehicle, which angle typically will correspond to an angle between a plane defined for the vehicle and that plane, or the horizon, that naturally exists in the scene of the surroundings being observed. Typically, the latter will be a plane defined as a plane which substantially is situated normal to the vertical axis, or a plane that is suspended by the position of the camera and a real horizon.

The roll compensator of the invention creates an image in one or more of the visualisation displays of the operator by rotating by an angle α the image that is acquired by at least one of the cameras before it is drawn on the display of the operator, as the angle α is an angle of a magnitude that corresponds to the angle being recorded by the head tracker, however, in the opposite direction. In other words, if the operator as an example tilts his head, or possibly his upper body, five degrees clockwise, the roll compensator in the solution of the invention will rotate the image from the camera five degrees counter clockwise before the image is rendered for the operator by being drawn on the display.

For situations having a scene that is located in a distance from the sensor head that is considerably larger than the distance between the two cameras of the sensor head from stereoscopic image rendering, it is considered sufficient to make the same roll compensation for both images. In situations where the image is located at a distance from the sensor head that is not considerably larger than the distance between the two cameras of the sensor head for stereoscopic image rendering, or where the roll is large between the plane of the stereo cameras and the natural “horizontal” plane of the scene, the roll compensation used in the invention for stereoscopic images is also adapted to make a translation of at least one of the images before it is drawn on the displays of the operator. The translation would typically be in what would be perceived as a vertical direction, and calculated on basis of a sensed head roll angle and the distance between the two stereo cameras of the sensor head, whereby it is achieved a compensation for the parallax like error that otherwise would have been in the rendering on the displays of the operator if roll compensation had been provided only by rotation of the images.

Preferably, the mid point in the image is selected as the point about which the image is rotated for roll compensation. In case of a rectangular image, the mid point of the image would typically be the point of intersection of the diagonals of the rectangle.

A system that comprises an embodiment of the present invention would include a sensor head with sensor electronics and a helmet having all operator control organs and operator electronics belonging to this.

The sensor head is preferably of a quality that allows it to be mounted outdoors, also for purpose of demonstration.

The operator part, i.e. the helmet with the display, the air phone and the microphone is preferably, also for purposes of demonstration, of a standard that can be shown to potential customers, such as e.g. in trade shows, and is adapted such that the functions may be demonstrated in a complete way.

The sensor electronics should preferably to as high a degree as possible be built by of the shelf parts and what would not prioritise to militarize this electronics.

In an embodiment made for demonstration, the sensor head would preferably be built by experimental mechanics.

The interface between the sensor head and the operator part is contemplated realized for demonstration purposes, is contemplated realized in a way simple as possible for implementing it for a test system, and is therefore not considered to be an optimal solution for an operational system.

In an embodiment of the present invention, it is particularly adapted for making possible a cooperation with a RWS that is capable of handling one target. By use of the near observation sensor of the invention, the operator of the near observation sensor stays in form of the overall situation and determines the next target, and provides a coordination towards the RWS-operator using one or more of a) audio intercom, b) pointing lasers of different colours, c) graphic indication of the pointing direction of both systems in the video images for both systems, d) indication of the aiming point of each other in video images, such as e.g. by use of different aiming crosses in case where the fields of the images overlap, or e) an automatic or semi-automatic transfer of target data from the surveillance sensor to the RWS.

The near surveillance sensor of the invention may comprise a control input from a joystick. The joystick is contemplated adapted such that it provides control signals for controlling the movements of the sensor head about at least one of the axis provided for the sensor head to move about. As previously mentioned, in an advantageous embodiment of the invention where the sensor head in adapted for movement about an azimuth axis and an elevation axis, the joystick may be adapted for two corresponding control directions. The controls for steering the sensor head is provided with inputs for control signals from the joystick, which typically is one for control in the azimuth direction and for control in the elevation direction. This provision of two inputs does not imply a limitation to only two physical inputs, as both control inputs may arrive to the steering controller as multiplexed signals in one and same transfer signal between the joystick and the steering controller. For that purpose, the steering controller is advantageously adapted such that it can select its source for signals that at any time arrives to determine the directions of the sensor head, such as e.g. through an input from a switch which can be operated by the operator for choosing between the steering of the sensor head from a head tracker or from a joystick. By changing between the head trucker and the joystick, the signal from the joystick would preferably be operating with reference to the position of the sensor head at the time when the change was made. This implies that if the joystick is in a neutral position at changing, the sensor head would remain in the position in which it was when the selection was made, and later assume other positions corresponding to a subsequent manoeuvring of the joystick. The steering controller has a memory that records the sensor position when the selection is made, and is adapted such that a selection back to the head tracker control preferably would lead to the sensor head going back to the position of the sensor head as it was when the previous selection was made for using the joystick.

A further possibility for the sensor head control by using a joystick in combination with the head tracker, is that the steering controller is adapted such that control signals that are provided by the head tracker and the joystick are superimposed or added for creation of the control signal that at all times controls the position of the sensor head. As an alternative, one of the head tracker signal and the joystick signal is provided to the steering controller as an addition to, or to be subtracted from, the reference that is applied for the sensor head control, and would as such control the basic position in relation to which the sensor head is directed as a consequence of the control signal that is provided to the steering controller by e.g. the head tracker.

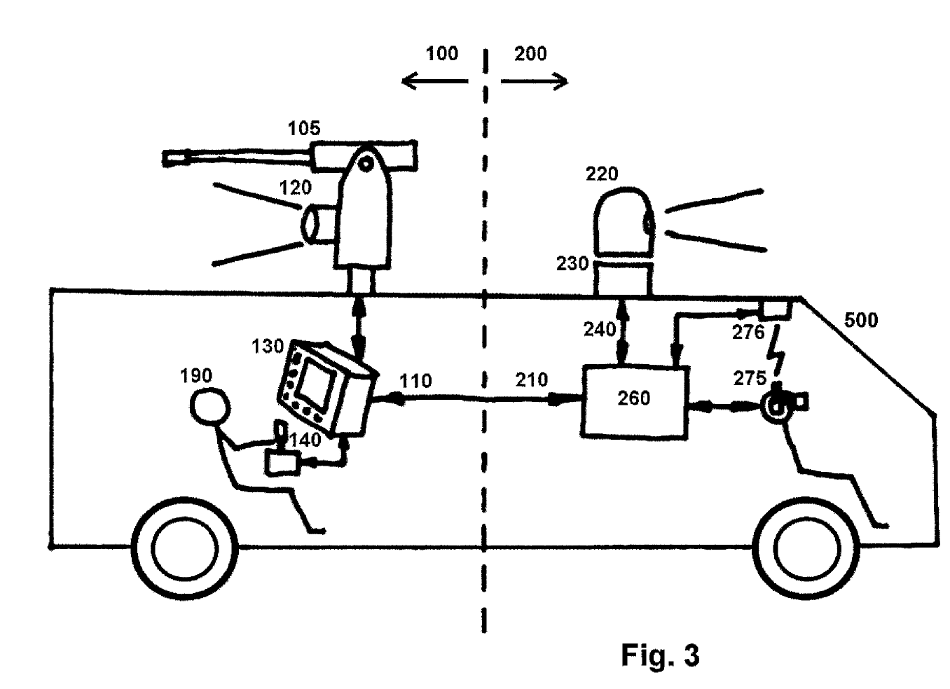

Further developments of the art disclosed by the applicant in the Norwegian Patent Application No. 20073983, filed in Norway on Jul. 31, 2007, from which the present application is claiming priority for the aspects described above, are disclosed in the text following this paragraph, and are explained with reference to the further accompanying FIGS. 3 through 11 in which:

FIG. 3 is a schematic drawing of a combat vehicle carrying a remote weapon station and an observation arrangement according to the invention,

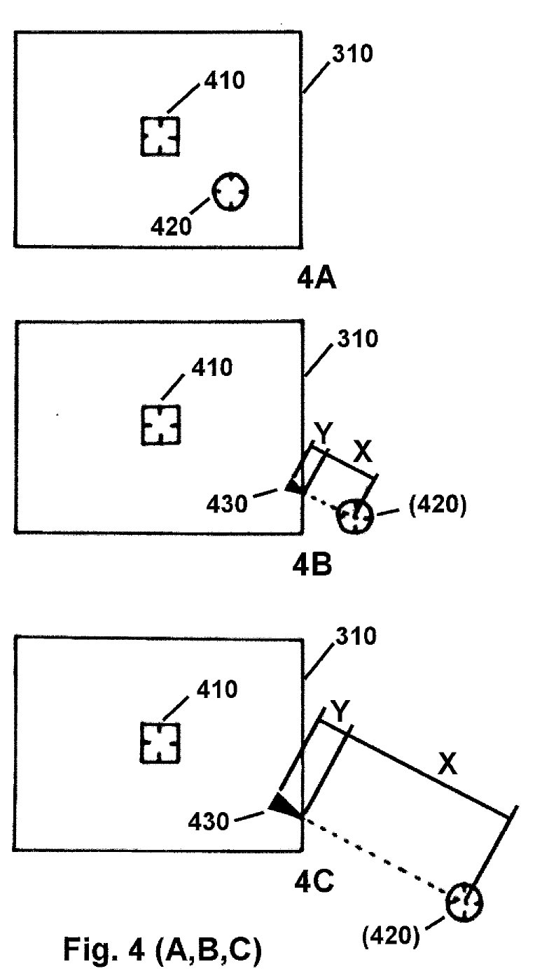

FIG. 4 illustrates schematically symbols displayed for the RWS operator and/or the OBS operator,

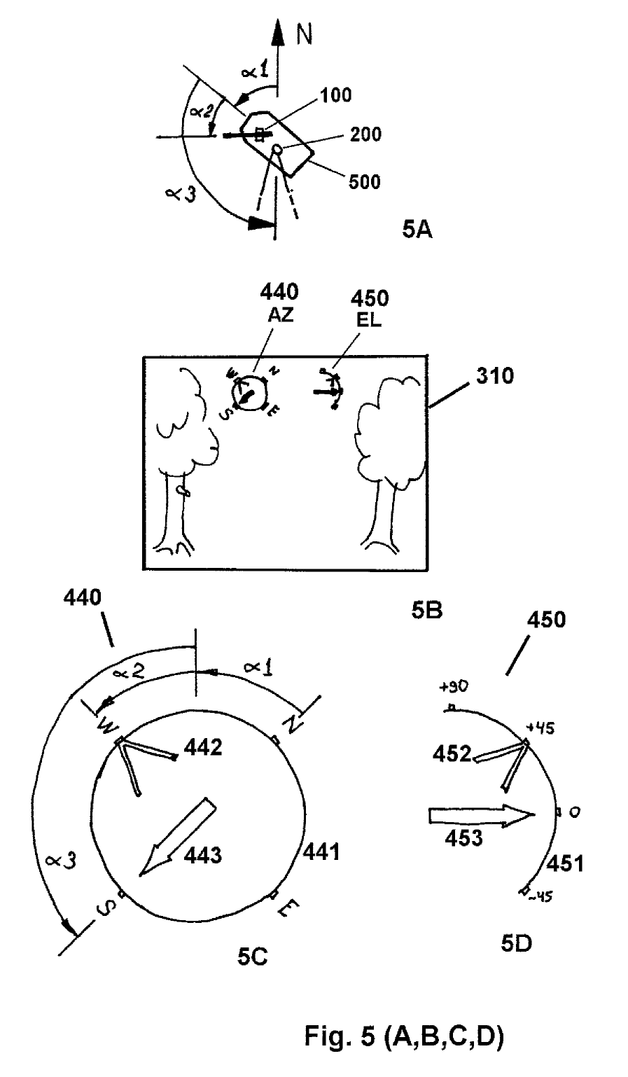

FIGS. 5 A, B, C, D illustrate schematically further symbols displayed for the RWS operator and/or the OBS operator,

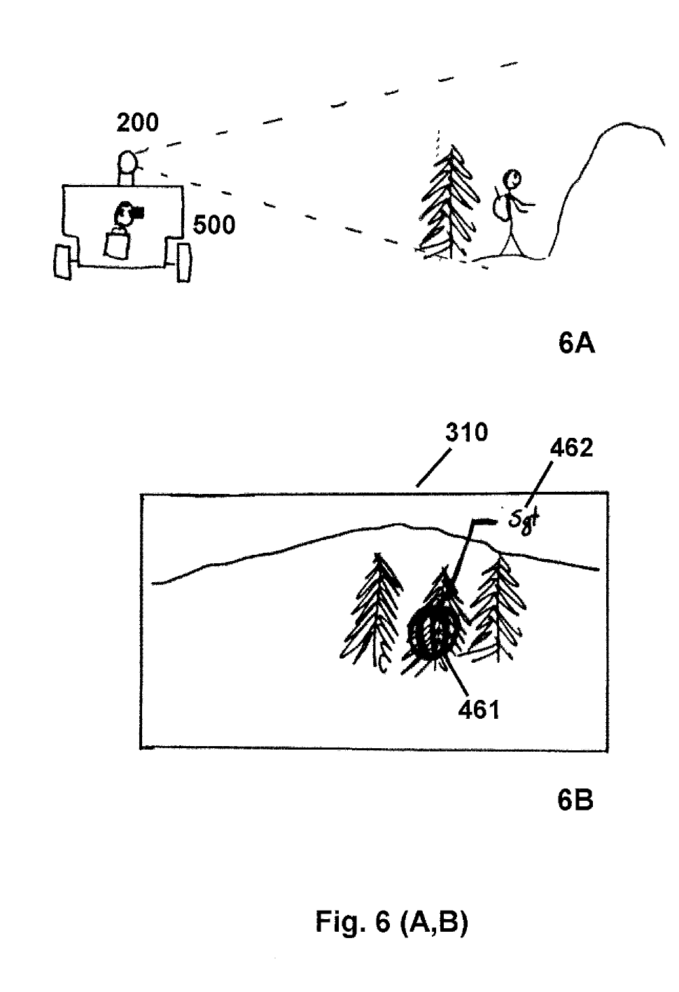

FIGS. 6 A, B illustrate symbols displayed for the OBS operator and/or the RWS operator in an OBS device according to the invention,

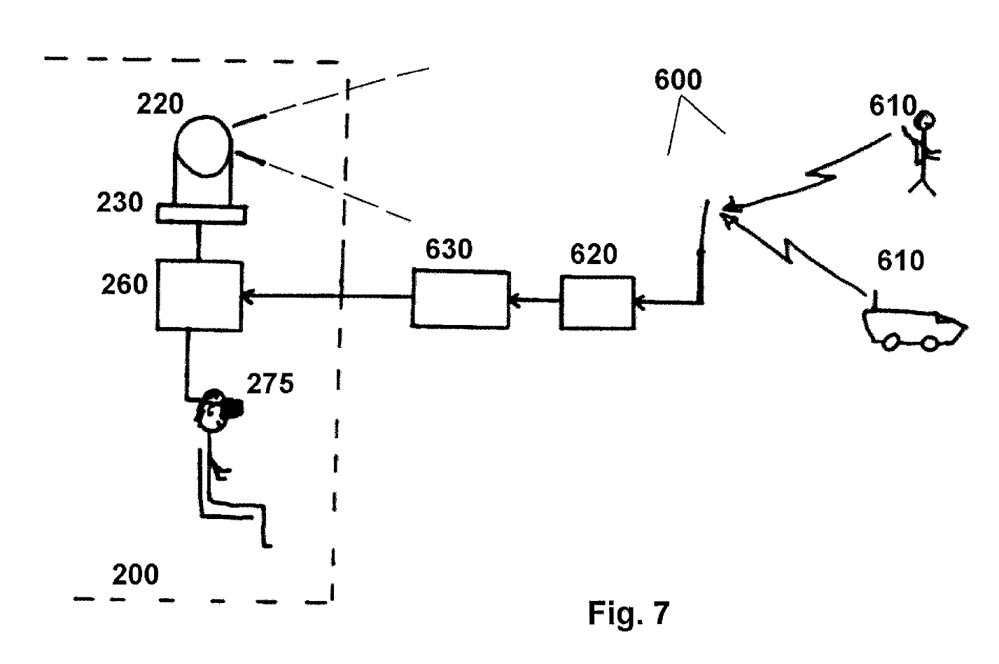

FIG. 7 is a partial block schematic drawing illustrating the OBS system according to the invention, adapted to cooperate with a patent management system,

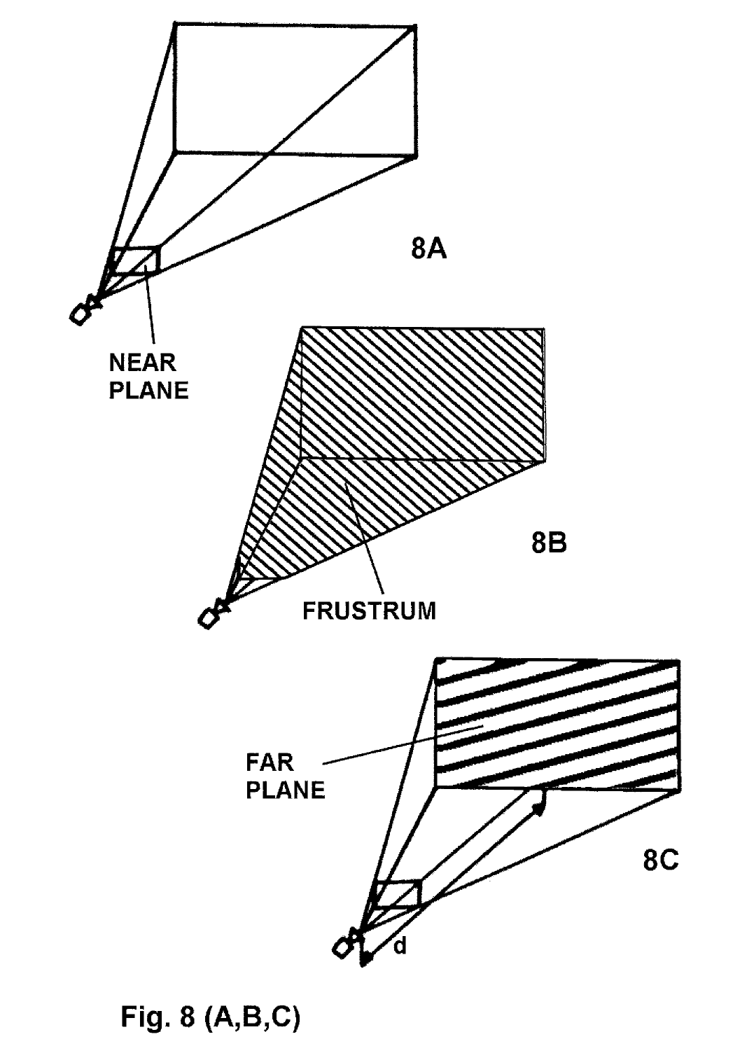

FIGS. 8 A, B, C illustrate schematically the geometric models for rendering in a three dimensional space graphically objects to be displayed for the OBS operator and/or the RWS operator,

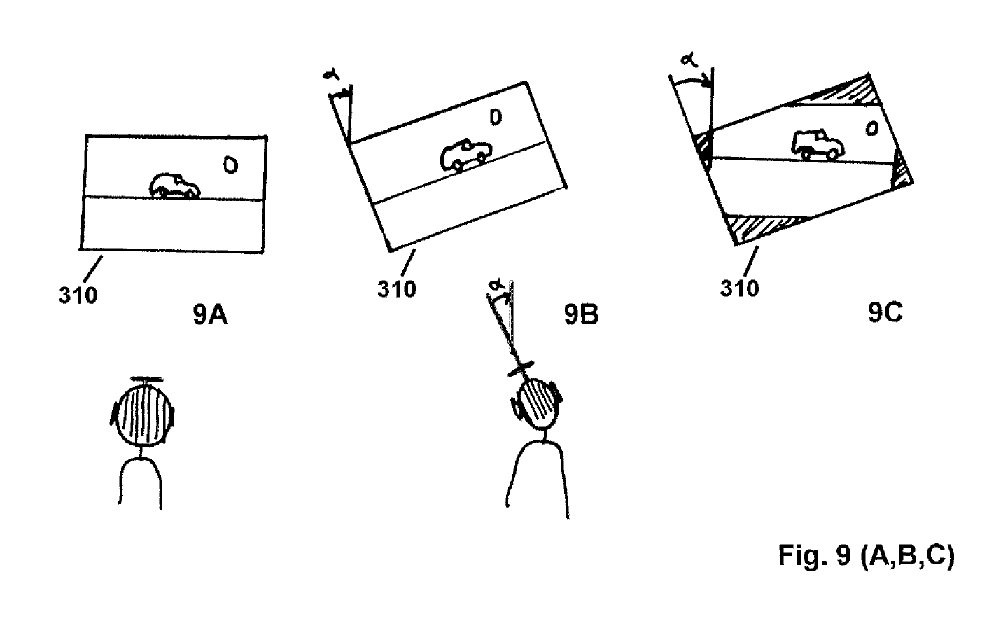

FIGS. 9 A, B, C illustrate schematically fed angle driven rotation of an image to be displayed for the OBS operator,

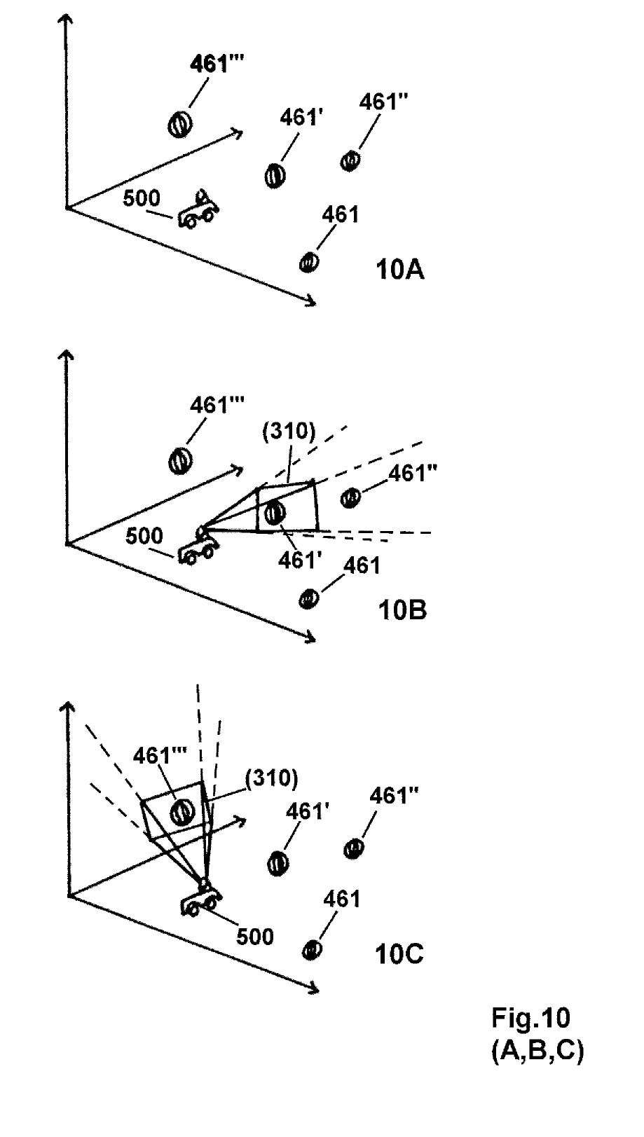

FIGS. 10 A, B, C illustrate schematically the rendering in a three dimensional space symbols to highlight or point out objects with known positions to be displayed for three dimensional imaging for the OBS operator, and

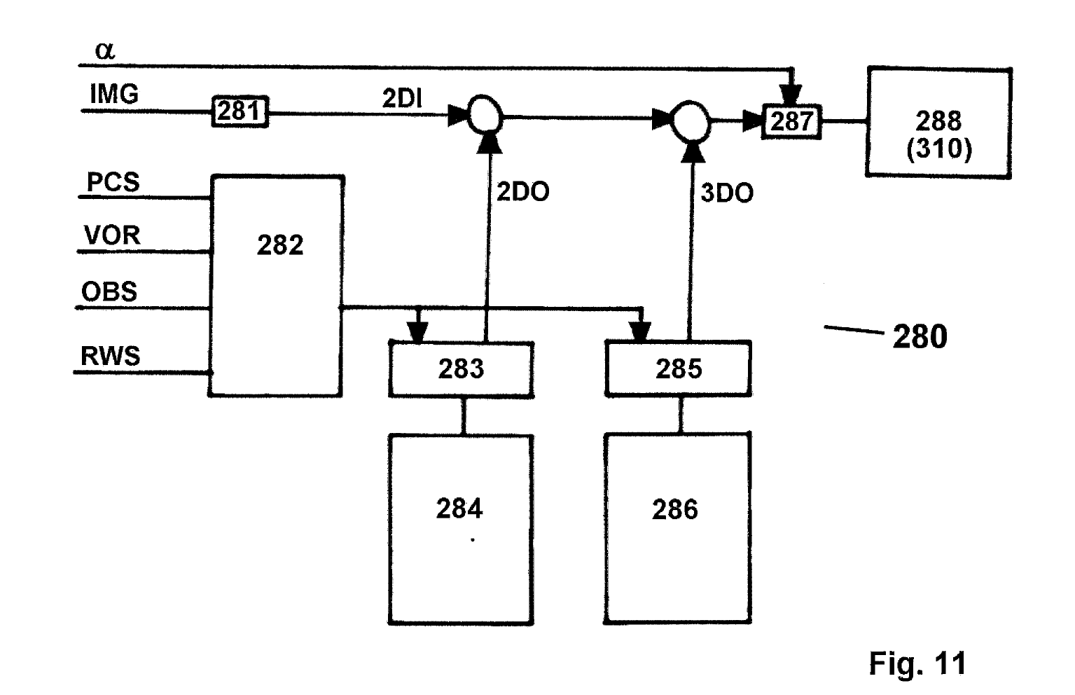

FIG. 11 is a block diagram to illustrate schematically an arrangement for generating an image on the operator display to combine real time image with real time objects in two and three dimensional observation space.

Reference is first made to FIG. 3, to illustrate generally further developments of the OBS system according to invention, exemplified by an installation in a combat vehicle 500, wherein reference numeral 200 with arrow pointing to right indicating part of system constituted by the observation system 200 according to the invention, and a remote weapon station (RWS) 100, to the left hand side part of the drawing. In FIG. 3 is illustrated that a communication channel is established between the far control unit (FCU) 130 of the RWS and the control unit 260 of the OBS system. Typically, the RWS 100 comprises a gun on a stabilized platform 105, typically movable about at least two axes, and a sensor of arrangement 120, typically comprising a day vision camera and possibly an infrared immature and/or a night vision camera. The remote weapon station 100 is controllable by an operator 190, typically by use of a joystick 140 in communication with the control unit 130, wherein the control unit 130 would include the display means to display for the RWS operator 190 an image required by the imaging sensor 120, and to provide control signals to the remote weapon station for aiming the gun 105 at a target or aiming point selected by the RWS operator 190.

In the further development of the OBS system 200 according to the invention, a data exchange interface 210 is provided in the control unit 260 of the OBS system of the invention, allowing the OBS system 200 of the invention to exchange data with the RWS control unit over the interface 110 of the RWS control unit 130. Thereby, the RWS operator 190 may be provided with information about the parts of a common scene that may be observed by the sensor 120 of the RWS and the sensor 220 of the OBS according to the invention, to enable handover of target, and even handover of control, such that information provided by the OBS system control unit 260 from the position of the head unit 275 of the OBS operator has tracked by the head unit tracker arrangement 276, allowing the OBS operator to determine the direction in which the RWS platform 105 should be directed.

Information exchange between the RWS control unit 130 and the OBS system control unit 260 is facilitated by exchange of data that allow the systems to draw symbols on respective display units of the RWS FCU 130 and the display of the head unit 275 for the OBS operator, making it possible for the operators to know at all times in which direction the other sensor is pointed, and, also to slave the remote weapon station to the OBS sensor, or vice versa.

Reference is now made to FIG. 4, A, B, C, for explaining the graphical overlay provided for orientation in the OBS image provided via the display of the OBS operator head unit 275 for the OBS system operator to be informed about the direction in which the RWS sensor 120 or the RWS pedestal 105 is aiming. First, with reference to FIG. 4 A, is explained the situation where the remote weapon station is aiming at a part of the scene which is within the field of view of the image displayed for the OBS operator. The substantially rectangular aiming symbol located centrally in the image being limited by the larger rectangle, while the circular aiming point symbol indicates the aiming point of the RWS. Moving now from FIG. 4 A to FIG. 4 B, the aiming directions of the RWS 105 (typically corresponding to the aiming direction of the RWS sensor 120) has shifted further with respect to the aiming point of the OBS sensor 220, to the point where the aiming point of the RWS is outside the field of view has displayed to the operator illustrated by the larger rectangle, by distance ex. outside the image, illustrating by an arrow on the lower right hand side of the boarder of the image, with a first length Y. The arrowhead is pointing in a direction towards which the OBS operator should move his head clearing the head unit 275 in order to again see the aiming point of the RWS 105, 120. In FIG. 4 C is illustrated the situation where the angular difference between the aiming direction of the RWS 105, 120 and the OBS sensor 220 has increased, which difference is obtained by the RWS FCU 130 and/or the OBS control unit 260, by the data exchange interface 110, 210, which is employed to compute a longer arrowhead to illustrate the larger angler difference between the aiming direction of the OBS sensor 220 and the aiming direction of the RWS platform 105, 120. Typically, the arrowhead is drawn or rendered on an imaginary line drawn from the centre point of the rectangular aiming symbol to the centre point of the circular aiming symbol, which, in the situations illustrated in FIGS. 4 B and 4 C, would not be visible for the OBS operator as they would be located outside the field of view that is displayed within the frame illustrated by the larger rectangular of the three FIGS. 4 A, 4 B and 4 C.

Reference is now made to FIGS. 5 A, B, C and D, for explaining further symbols provided to the operator of the RWS on the display of the RWS FCU 130. This scenario used to illustrate the graphical overlay symbols is shown in FIG. 5 A, with the combat vehicle 500 illustrated with a heading angle α 1, referenced to true North heading N, with the RWS 100 pointing in a direction angle α 2, referenced to the heading of the combat vehicle 500, and the sensor 220 of the OBS system 200 of the invention making observations in the direction at an angle α 3 with respect to the heading of the combat vehicle 500.

FIG. 5 B illustrates the overlay symbols drawn in an image required by the OBS sensor 220 and displayed to the OBS operator by way of the display provided by the head mounted unit 275. In FIG. 5 B is shown a scenario, and in the upper left half of the screen the symbols for providing information about azimuth directions, and on the upper part right hand side, the symbols for providing elevation angle information. The graphic overlay symbols for displaying azimuth angle information is indicated by the letters AZ, while the symbols for providing information about the elevation angles, are marked by the letters EL. Further details of the overlay symbols drawn in the image for orientation in the image provided to the OBS operator are now explained with reference to FIGS. 5 C and 5 D. First, with reference to FIG. 5 C, is explained details of the graphic overlay drawn in the image displayed to the OBS operator for displaying information about pointing angles and angles of the vehicle in the horizontal claim, here referred to as azimuth angle information. In an advantageous embodiment of the invention, the symbols for displaying azimuth angle information, the heading of the vehicle 500 is maintained as the reference, typically by maintaining a vertical line in image as a reference for the heading of the vehicle 500. Accordingly, a case where the vehicle 500 is heading in a true North direction, which direction is indicated by the arrow and the capital N letter in the scenario illustrated in FIG. 5 A, the circle illustrated in FIG. 5 C with quadrant indications N, E, S, W for the direction North, East, South and West, respectively, would be oriented with the N at the top and the letter S at the bottom, to indicate to the OBS operator that the heading of the vehicle 500 is to the North. Thus, by turning the vehicle to the left by an angle α 1 with reference to true North, which is the scenario illustrated in FIG. 5 A, the symbol overlay in the image would assume the attitude illustrated in FIG. 5 C, with the circle carrying the four compassed directions rotated slightly to the right by the angle α 1, thus informing the OBS operator wearing the display head unit 275 that the vehicle is positioned with a North-West heading offset an angle α 1 from the true North direction. Additional information with regard to the pointing directions of the weapon station 105 of the revolt weapon station system 100 and the observation direction of the sensor head 220 of the OBS observation system 200 of the invention are provided by a reshaped arrowhead to indicate the aiming direction of the RWS weapons platform 105, and a full arrow to indicate the direction in which the sensor head 120 of the OBS sensor system 200 is looking, respectively. In the example of FIG. 5 C, the aiming direction of the weapons platform 105 of the RWS system 100 is shown by the reshaped arrowhead is aiming towards West, at an angle α 2 counter clockwise referenced to the heading of the combat vehicle 500, while the OBS sensor head 220 is looking towards the South at an angle α 3 counted clockwise when referenced to the beading of the combat vehicle 500.

Corresponding to the symbols for displaying aiming or pointing angles in the base plane of the combat vehicle 500, a further symbol set for displaying elevation information referenced to the base plane of the combat vehicle 500 is illustrated in FIG. 5 D. The reshaped arrowhead of FIG. 5 D indicates in the example scenario of FIG. 5 A that the weapons platform 105 of the remote weapon system 100 is positioned to an aiming direction of 45 degrees up with reference to the base plane of the vehicle 500, while the OBS sensor 220 is positioned to look in a direction of 0 degrees referenced to the base plane of the vehicle 500, indicating that the OBS sensor 220 is looking in the direction parallel to the base plane of the vehicle 500.

The symbols provided as displayed and illustrated in FIG. 5 D for displaying information about the elevation angle is maintained with the ark drawn in this example from ÷45 degrees to +90 degrees as stationary to follow and be tied to the base plane of the vehicle 500. However, it is contemplated to provide an additional graphical symbol to indicate the inclination of the vehicle with respect to a horizontal plane of the scene to be observed, or to maintain the zero reference of the ark illustrated as drawn from ÷45 degrees to +90 degrees in FIG. 5 D to the horizontal plane of the surroundings and then introduce a further symbol to provide information about the inclination angle of the vehicle base plane in the direction in which the OBS sensor head 220 is looking.

Next is explained the use of the angler information provided by the OBS system 200 of the invention for controlling the remote weapon station and in particular the weapons platform 105 of the RWS 100. By way of the data communication interfaces 110, 210 between the control unit 260 of the OBS system 200 and the FCU 130 of the remote weapon station system 100, the remote weapon station system 100 is further adapted to be controlled by, or slaved to, the direction in which the sensor head 220 is pointing, or, as an option, a positioned offset from that in case the OBS operatives is provided with further pointing device that may be used to select an aiming point within the image displayed to the OBS operator that may be located differently from the aiming symbols illustrated to be located in the centre part of the image in the example illustrated in FIGS. 4 A, D, C. In an embodiment of the remote weapon system adapted to be controlled by the information provided by the OBS system control unit 280, the RWS system operator 190 is provided with a control element, such as for example a push button switch, to allow the RWS weapons platform 105 to track the OBS sensor head 220. When the RWS system is enabled for tracking the OBS sensor head 220, which in turn is arranged to track and follow the movements of the fed of the OBS operator carrying the head gear 275 by way of the head gear tracker 276, the OBS operator has at his disposal a push button switch or similar control element to control feeding of data from the OBS system control unit 260 via the data communication interface 210, 110 to the FCU 130, making the RWS weapons platform 105 to rotate automatically to be pointing in the same direction as the OBS sensor head 220. The RWS weapon station platform 105 includes the sensors 120 with a direction finder, which information from the direction finder is provided also to the FCU 130 and the OBS control unit 260 to control any aiming errors to compensate for any parallax errors due to different positions of the weapon station platform 105 and sensor 120 and the OBS sensor head 220. With the RWS operator control element, the RWS operator 190 may at any time regain control of the weapon station to aim the weapon station platform 105 with sensor 120 to aim in a different direction from the aiming or looking direction of the OBS sensor head 220. The aforementioned function is referred to herein as the go-to function. Thus, the OBS system operator wearing the head gear 275 may observe the surroundings to look for targets and automatically provide target direction information to the RWS system operator 190 who, by enabling the tracking function or go-to function would allow the weapons platform of the remote weapon station to immediately go to the aiming point of the OBS sensor head 220 to immediately require target provided and found by the OBS operator of the OBS system 200. For safety, it is contemplated that the RWS operator 190 provides and acknowledgement of the use of direction data provided by the OBS system 200 for the go-to function before the weapons platform 105 is allowed to start rotating towards a direction determined by the OBS sensor head 220. As an alternative to providing over the data communication interface 210, 110 data representing the direction in which the OBS sensor head 220 is looking, data delivered to the FCU 130 may be representing a geographical position by way of geographical co-ordinates, and the RWS operator 190 is provided with a control function to allow the RWS weapons platform 105 to be commanded to aim at a location corresponding to the geographical co-ordinates provided.

Two facilitates automatic slaving of the aiming of the RWS weapons platform 105 to the aiming point of the OBS system 200, it is contemplated that the OBS operator or the RWS operator 190 has at his disposal a control button to control continuously feeding of direction data representing the direction in which the sensor head 220 is aiming, over the data communication interface 210, 110 between the OBS control unit 260 and the FCU 130, and adapted such that the RWS reference platform 105 is slaved to the direction into which the OBS sensor head 220 is looking for as long as the operator keeps the control enable. In a practical implementation of this function, the operator may be provided with a push button switch which enables the tracking as long as the pushing button switch is maintained the press. To ensure safety in slaving and also the operation of the weapons platform 105 of the RWS system 100, the RWS operator 190 is provided with a further switch to provide a confirmation to allow and enable the tracking function.

Reference is now made to FIGS. 6 A and 6 B, to explain the provision of graphical symbols drawn to overlay in the image displayed to the operator of the OBS system 200, or on the image displayed to the RWS operator 190 of the RWS system 100, which symbols are provided and displayed as they are “attached to” own forces, and which also include a text field for identification information. The symbols are drawn and displayed as based on the geographical position to be known from information sources that maintain updated about the geographical occasion of own forces.

Corresponding to symbols that are “attached to” own forces, the symbols may be drawn to indicate other important objects, such as for example pre-defined targets, land marks, important buildings, etc., with a corresponding text field for by the information. The symbols of the aforementioned objects would be provided to the system based on geographical information.

Also corresponding to the symbol to show the location of own forces and other important objects, is an interactive marking of objects. By using the range finder, such as the laser range finder provided in the sensor package cooperating with the weapons platform 105 of the remote weapon station system 100, and also the directional orientation of the sensors, the geographical position of objects observed in the scene may be determined. The operator is provided with a function to “attached” a symbol to an object with a position determined as indicated, and then distribute at geographical information to other units such that the symbol also will be displayed to the operators as overlay symbols on images provided by their own sensors. In a way corresponding to what was explained above for a go-to function or slaving of the RWS weapons platform by using the direction data provided by the OBS sensor head 220, the position of other data provided to other units may also be used in the other units for a automatic go-to of the weapons platform of other units to targets marked by using the aforementioned function.

As an example, FIG. 6 A, B illustrate first in FIG. 6 A the combat vehicle 500 provided with the OBS sensor system 200 of the invention looking in the direction towards a scene including in the foreground objects blocking the view towards other objects located in the background, which in the case of the scenario of FIG. 6 A is represented by on forces in a known position or location. The information about the known position or location may be obtained from other sources, such as for example a combat plan according to which the own forces should be at a certain position at given time, which information is provided to the system to draw and overlay symbol as illustrated in the image of FIG. 6 B by a circular object and an identification indicator to show the sergeant is located in the scene behind the three objects in the foreground. The location information could be real time location information provided by a communications leakage between the on forces and the OBS system 200 in the vehicle 500, such as a OPS location transferred by radio to the OBS system control unit 260, which would use the location information and identification information provided over the radio interface to draw the overlay symbol to show the sergeant located behind the three as shown in FIG. 6 B.

It is further contemplated that the OBS system 200 of the invention could be used by the driver of the combat vehicle 500 to further argument the driver's access to information of the terrain in which he is driving the combat vehicle 500. When driving in a foreign terrain, the image of the terrain is further augmented by applying synthetic rolled science as overlay symbols on the image provided to the driver, for example by using the language of the driver, and optionally, position the rolled science in such a way that they are always readable while at the same time indicating the correct direction for driving. Further more it is contemplated to include a three dimensional “rope” in the terrain to show the planned choice of route through the terrain. Arrowheads could be located at intervals along the “rope” to show the direction in which to drive. As a further option, a three dimensional “rope” could be provided in image as an overlay symbol for a driver turning his head to look backwards, which may be used later as a clue for a turning back to the starting point, such as for example returning to base. The three dimensional “rope” overlay symbol could also be provided based on information from to other vehicles having driven to the terrain or planned to drive, and to allow the driver to follow the same route, or to deviate from the route if considered advantageous. The “ropes” could be distinguished by drawing the symbols in different colours. A further overlay of the image provided by the OBS sensor head 220 is contemplated in form of a grid to display the three dimensional shape of the terrain to further enhance the image in case of low visibility or darkness.

In the following, further details of the aforementioned, further developments will be explained in more detail.

With reference to FIGS. 4 A, B, C, the overlay graphic for orientation in the OBS image will be explained in details. The system draws the “overlay” graphics in the image field 310 of the OBS, which show the aiming point 410 of the OBS and the aiming point 420 of the RWS. Different symbols are used for the two aforementioned aiming points, which are illustrated by aiming point symbols 410 and 420 for the OBS sensor 220 and the RWS sensor 120, respectively. Functions to be described are dependent on that the RWS and the OBS exchange data about the angles referring to the positions and directions of the mechanical joints of the system, and that navigation data describing the orientation of the vehicle are provided to the OBS system 200 from the RWS system 100. The shape of the symbols may advantageously be as illustrated in FIGS. 4 A, B and C. In FIG. 4 A is shown an example of symbols for displaying the aiming points or aiming directions, wherein the aiming point 420 of the RWS weapon platform 105 and associated sensors 120 are within the image field 310 of the OBS system 200. The aiming point 410 of the OBS 200 is shown by way of a rectangular symbol centred in the image field 310, while the aiming point 420 of the RWS is shown by a symbol or circular shape. The symbols are contemplated to be drawn with different colours to distinguish them further. Any symbols where presenting data of the RWS system 100 are drawn in colour red, while symbols representing the OBS system 200 are drawn in a green colour.

In FIG. 4 B is illustrated how the aiming point 420 is marked when it is in a location where it would have been drawn outside the image field 310 of the OBS system 200. To illustrate that the aiming point 420 of the RWS is not actually drawn in the image field 310, the reference numeral 420 has been placed in buckets. In the situation as shown in FIG. 4 B, an arrow were presented by the arrowhead 430 symbolises the direction in which the head gear 275 of the OBS operator should be moved, or rotated, to bring the aiming point 420 into the image field 310. The arrowhead 330 is drawn in the size representing the magnitude of the angle difference between the direction of the aiming point 410 of the OBS system 200 and the aiming point 420 of the RWS system 100. That difference is illustrated by a comparison of FIGS. 4 B and 4 C, wherein in FIG. 4 C the arrowhead 430 is drawn in a larger scale than the arrowhead 430 drawn in FIG. 4 B, as the larger angle separation between the aiming directions of the RWS reference platform and the OBS sensor head are increased, indicated by the ratios of the distances X to Y.

Turning now to FIGS. 5 A, B, C and D, the symbols drawn in the image field to indicate directions of aiming of the weapon stations platform and the sensor head 220 of the OBS system 200, and also the heading of the combat vehicle 500 with respect to true North will be further to explain. An exemplary scenario is illustrated in FIG. 5 A, in which the combat vehicle 500 is provided with a remote weapon station system 100 as well as an observation system 200. Three angles α 1, α 2 and α 3 are drawn in the figures, wherein α 1 is the angle separation between the true North direction and the heading of the vehicle 500, the angle α 2 is the angler separation of the aiming direction of the RWS reference platform 105 and associated sensor 120 and the heading of the vehicle 500, and the angle α 3 is the angler separation of the viewing direction of the OBS sensor head 200 and the heading of the vehicle 500.

FIG. 5 B illustrates how the aforementioned three angles and the elevation angles of the sensors are displayed by use of overlay graphics in the upper part of the image field 310 provided by the system of the invention. The symbol to the upper left hand part of the image field displays angles in an azimuth plane, which might be referenced to a horizontal plane or to a base plane of the vehicle 500, whereas the symbols in the right hand of the part of the image field 310 provide information about elevation angles.

In FIGS. 5 C and 5 B are provided for the details about the azimuth angle symbol 440 and the elevation angle symbols 450.

In FIG. 5 C is illustrated that the heading of the vehicle 500 is maintained in the azimuth angle symbols 440. The compass angle of the vehicle 500 is provided by a compass ring 441 which, as the vehicle 500 changes its heading, would appear to rotate opposite to the change in the heading direction of the vehicle 500. The aiming direction of the RWS weapons platform 105 and associated sensors 120 with respect to the heading of the vehicle 500 is drawn with the open “V”-shaped arrowhead 442 symbol located at the inside of the compass circle, which would rotate to follow the aiming direction of the RWS weapons platform relative to the vehicle, also indicated by the angle α 2. Thus, the compass direction of the heading of the RWS platform 105 and associated sensors 120 may be determined from the direction of the compass circle 441. The angler orientation of the OBS sensor 220 with respect to the vehicle is indicated by is the arrow 443 originating at the centre of the circle, and is rotating with the rotation of the OBS sensor 220 with respect to the heading of the vehicle 500. Thus, also the compass angle orientation of the OBS sensor 220 can be determined from the position of the arrow 443 with respect to the compass circle 441.

Accordingly, for the elevation symbols 450, shown in detail in FIG. 5 D, the open arrowhead, “V”-shaped symbol 452 displays to the operator the elevation angle of the RWS weapon platform 105 and associated sensor 120 which, in the scenario illustrated in FIG. 5 D is elevated at +45 degrees with respect to the base plane of the vehicle 500, whereas the OBS sensor head 220 is looking in its aiming direction displayed by the arrow 453 in a direction of 0 degrees with respect to the base plane of the vehicle. In the illustration of FIG. 5 D, the symbol range has been limited to 45 degrees below the base plane of the vehicle and to a maximum of +90 degrees above the base plane of the vehicle 500, as considered practical to provide the information about elevation angle. Although herein explained with the elevation angle displayed with reference to the base plane of the vehicle, the reference could instead be the horizontal plane of the terrain in which the vehicle is located, with a further symbol to display the angler orientation of the vehicle which, depending on the direction in which the RWS platform 105 and associated centres 120 is aiming, or the sensor head 220 is aiming, could display the pitch, yaw or roll of the vehicle 500 as additional information that would be useful for the operator of the OBS system 200 or the operator 190 of the RWS system 100 for aiming the weapon station or for providing such information to other units in the area.

In an embodiment of the aforementioned to-to function of the combined RWS system 100 and OBS system 200, they include means supporting the commandment of the aiming direction of the RWS weapons platform 105 and associated sensor 120 from the OBS system 200. When the push button switch made available to the operator of the OBS system 200 is activated for a “go-to” mode, the operator momentarily operates the push button switch for recording information about the current aiming direction of the OBS sensor 220 with respect to the vehicle 500. The OBS system 200 processes the angler information recorded and obtains a weapon range information from the RWS sensor 120, and makes calculation to determine the angles by which the RWS platform 105 and sensors 120 must be commanded to pitch or rotate for the RWS weapons platform 105 to aim at the same aiming point as the aiming point provided by the OBS sensor 220. The angles determined are forwarded to the RWS system 100. The RWS system 100 is provided with the new means adapted to receive the angle information from the OBS system 200, and employs the received angle information as reference angles for the sensor systems of the RWS system 100 in a process of redirecting the RWS weapons platform 105 and associated sensors 120 until the new direction indicated by the go-to function is reached. To start directing the RWS platform on basis of the information provided by the OBS system 200, the RWS system 100 is provided to operate in one or two modes, or in the first mode is a fully automatically mode wherein the weapons platform is reoriented immediately upon receiving regular information from the OBS system 200, and in the second mode, the reorientation of the RWS weapons platform 105 and associated sensors 120 is maintained on hold until the RWS operator 190 provides a confirmation input to the RWS system 100.

The OBS system 100 is contemplated to provide means for operating the system, as an operator panel, provided with a “select” button useful for selecting one or several objects being drawn as symbol by use of overlay graphics based on a three dimensional or geographic position. Plotting of symbols on three dimensional objects are further explained in the subsequent part of this description. This election is made by the OBS system operator turning his head until the symbol for the object of interest is drawn inside of the aiming symbol (see FIG. 4 A, B, C, symbol 410), and then operates the “select” button. The system is arranged to change colour of the symbol and all text based information about the object displayed as only graphics in the image displayed to the operator. If the operator performing a “go-to” function while an object is selected, the RWS weapons platform 105 and associated sensor 120 are provided with commands to change their aiming direction to a direction corresponding to the direction of the selected object, and, additionally, to maintain the selected aiming direction toward the object also in case that the vehicle 500 is in motion and changes its attitude or direction. In an advantageous embodiment of the invention, the aforementioned function is provided by algorithms operating in a processor of the FCU 130, adapted to make dynamic triangulations between the position of the RWS system 100 and/or the observation system 200, and the position of the target.

The aforementioned slaving of the RWS weapons platform 105 and associated sensors 120 is partly achieved using the means provided for the go-to functions, however, being different in that when the operator of the OBS system 100 keeps the push button switch depressed for slaving, the RWS weapons platform 105 and associated sensors 120 are slaved to aim in the same direction as the viewing direction of the OBS sensor head 220. The RWS FCU 130 processing function is adapted to slave the aiming direction of the weapons platform 105 and associated sensors 120 to the viewing direction of the sensor head 220 until the operator of the OBS system 200 releases the button, at which time the RWS system operator 190 reassumes control of the RWS system 100. The RWS system 100 should be provided with an override control to allow the RWS system operator 190 to disable the tracking function. The selection of the various operating modes as described herein is made by the RWS operator 190 by way over control function provided through the FCU 130. The slaving or tracking function is provided through a continuous transmission of angler information from the OBS system 200 to the RWS system 100 via the data communication link interfaces 210, 110 illustrated in FIG. 3. Advantageously, the information regarding the direction of the sensor system 220 of the OBS system 200 is employed as reference angles for the service system of the RWS system 100, serving to drive the RWS weapons platform 105 and associated sensors 120 to aim in a direction that corresponds to the aiming direction of the OBS sensor head 220 and, advantageously with corrections for any parallax due to different mounting positions by employing also data obtained by the range finder of the sensor system 120 of the RWS system 100.

Reference is now made to FIGS. 6 A and B, for explaining symbols for objects based on geographical position.

The symbols for objects based on geographical position are based on the principle for real time updating of GPS positions, provided by own forces. In the scenario illustrated in FIG. 6 A, this soldier is located behind trees obscuring the person from being observed by the sensors of the OBS system 200 of the invention, while objects in the foreground, such as trees, may be observed. In the scenario illustrated in FIGS. 6 A and B, this soldier is provided to carry a GPS receiver and a transmitter to transmit the GPS position of the soldier at frequent intervals. Typically updating will be provided with intervals of few seconds. The GPS position of the soldier is plotted in the three dimensional space being observed by the OBS sensor 220, and draw in the image, providing the OBS operator information to see that soldier is located in the area of trees in the scene image to the operator. As the operator is enable to observe the soldier due to the trees locate in the foreground, while being provided with a symbol as 461 and further information 462 with regard to the meaning of the symbol, the operator can conclude that the soldier is located behind the trees. While providing the soldier with a transmitter capable of transmitting further data to describe the object, together with the position information, such information is also drawn within the image field 310 to show identification data related to the symbol 461, such as for example “sniper”, “private”, “tank”, “personnel vehicle”, “Stryke”, etc. By rendering the symbols within the image field 310 in the foreground to visualize advice hidden objects, as compared to providing is symbols for such objects on a digital map, is that trees, buildings, vehicles, other soldiers/civilians and other objects that also are capable of moving about may be identified. This identification improves the operators understanding of the current situation.

Reference is now made to FIG. 7, which illustrates a system for plotting own forces and for connecting the OBS system 200 of the invention to an external system 600. The external system 600 comprises a battle unit 610, such as a soldier or other vehicle 610, with radio communication, providing through the external system a radio receiver 620 and the BMS battle management system 630 adapted to provide to the OBS system 200 of the invention battle information such as selected the GPS positions to be sent to the OBS system 200 for plotting and display to the OBS operator via the head gear display unit 275. In this scenario illustrated in FIG. 7, the soldier or vehicle 610 are provided separate OPS to determine on location, and location data are forwarded via radio to receiver 620 in the combat vehicle 500, via the antenna radio, and further to the battle management system 630. The battle management system forwards the GPS positions to the OBS system 200. The OBS system creates objects to be drawn as graphic elements in the image field 310 being displayed to the OBS operator via the display parts of the head gear 275, thereby providing a graphic overlay allowing the operator of the OBS system 200 to view a scene with overlay graphics to identify the location of battle unit 610. As an augmentation to the aforementioned system, a simpler variant of functions can be provided, wherein the geographical position is pre-determined and is not continuously updated. the OBS system 200 stores the position previously determined, and creates a graphic object for the overlay display when the image field 310 covers such positions that correspond to the determined geographical position of the object of interest, and draws the corresponding symbol to represent the object when the determined position is within the frustum of the camera of the OBS sensor 220. By employing information provided by the range finder of the remote weapon station platform sensors 120, and any navigation system provided in the vehicle 500, the actual geographic position of a target may be determined. Such position being determined is stored in the OBS system control unit 260 or other associated stores devised, and then displayed in the image when the position or location is found to be within the frustum of the camera providing the image data in the image field 310. Also, a position or located such determined can be forwarded from the OBS system 200 of the invention to be battle management system 630 illustrated in FIG. 7, for its further distribution to other battle unit 610 for use there in a corresponding way as previously split in for data that was provided from the battle unit 610 to the OBS system 200 of the invention.

In an advantageous embodiment of the invention, the OBS system 200 may provide display information and an image to the driver of the vehicle, for the driver to use it as its main sensor for orientation in the terrain and/or other traffic in the area. Typically, also for use in the driver situation, plotting of objects based on geographical three dimensional co-ordinates will be as earlier explained, however, the system will be provided with several additional functions to facilitate its use for the driver function. When driving in and on an area with no or little signs for road signs or the road signs are in a foreign language, the system is adapted to generate and display synthetic road signs. Such synthetic road signs must be added to the system in advance, or may be downloaded via a separate communication link from a central source or from other battle unit 610 via the battle management system 630, or, possibly, via direct links from the other battle unit 610 to the current OBS system 200 of the invention. Such synthetic road signs to be drawn as symbol overlays in the image field 310 would typically be based on having made studies of maps and provided definitions for the locations of the road signs in the terrains in three dimensional geographic co-ordinates. The text and directions for pointing the driver is information to be provided to the system. Thus, any language may be selected for the information to he provided by text of the symbols drawn an overlay on the image in the image field 310. For the user of the obvious system 200, in particular in the case where user is a driver of the vehicle 500, the synthetic road signs will appear to be located physically in the terrain being image in image field 310, and would enhance the operational capability as their signs made synthetically will be drawn in a colour and with an intensity sufficient to be seen regardless of the visibility or light conditions in the scene being imaged through the camera sensors of the sensor head 220 of the system according to the invention. As briefly explained in an earlier part of this description, a three dimensional “rope” or “track” may be located in and overlaid on the image of the image field 310 to show a planned route selected for moving through the area, and, optionally, with arrows or arrow heads at certain intervals located on a track or “rope”, to show direction in which the vehicle or driver should be moving or heading. Such functions are provided by recording the route to be passed by the vehicle as a number of geographic three dimensional co-ordinates, and drawn as line sections between such co-ordinates. These line sections are then displayed as overlay graphics on the image field 310 by the plotting function to be explained in a later part of this discloser. Plotting or drawing of a grid as a graphic overlay on the image in the image field 310 to show the tree dimensional shape of the terrain is provided by projecting a selected grid size on to a three dimensional description of the terrain. The three dimensional description of the terrain may for example be a map database such as DTED1 or DTED2. The grid projected should then be represented by line elements described in three dimensional geographic co-ordinates and be displayed as overlaid graphic by the means of method being described in the following.

Reference is now made to FIGS. 8 A, 8 B and 8 C for describing plotting of objects based on three dimensional geographic positions.

In FIGS. 8 A, B and C, a camera is drawn in a lower left part of each figure, and has a field of view drawn in azimuth and in elevation. The small rectangle closed to the camera is referred to as the “new plane”. Objects being closer than the new plane are not drawn as symbols for overlay graphics. The larger rectangle located up and to the right of each figure is referred to as “far plane” and objects located further way where the far plane are not drawn as objects for the overlay graphics.

The apparent pair of medical shape are, according to what was explained above, restricted to what lies between “new plane” and the “prior plane”, and is herein referred to as the “frustum”. Only objects lying within the frustum will be drawn for display as objects or elements for the graphical overlay.

For superimposing the graphical overlay to be visible to the viewer observing the image provided in the image field 310, reference is made now to FIG. 8 C, wherein the hatched area represents the video image provided by the camera or cameras of the OBS sensor head 220. The review of the hatched area is applied as a texture to a two dimensional surface in the model. A two dimensional surface in a three dimensional drawing is also referred to as a “sprite”. The image or sprite are located at the “far plane”, because objects being located behind the “sprite” otherwise would not be drawn, and it is desirable to draw all three dimensional objects that are located in the frustum. In FIGS. 8 A, 8 B and 8 C is indicated a distance setting between the camera and the sprite. This distance determines how close a three dimensional object may be with relation to the camera to be drawn. The distance may be adjusted, and has as consequence that the size of the sprite (and the video) must be sealed to fill the field of view. At longer distances, three dimensional objects that are located further way will also be drawn in the overlay graphics.

Reference is now made to FIGS. 9 A, B and C to explain image rotation in response to a roll movement of the head gear 275 with reference to the head position detector 276 of the system.

Referring first to FIG. 9 A, the image provided in the image field 310 and the operator are provided as corresponding to each other. The FIG. 9 A illustrates what the image would look like to the operator in the display when maintaining his head at 0 degree roll angle with reference to the base plane of the vehicle 500 to which the head tracker unit 276 is attached. FIG. 9 B illustrates the image displayed in image field 310 to the OBS operator wherein the head gear with the display unit 275 when the operator tilts his bead by an angle α when no tilt compensation is enabled. Accordingly, the image will follow the tilt movement of the head, and give the OBS system operator an impression of a tilting of the horizon that follows the tilting overhead, that this tilting of the horizon by the angle α when the head is tilted by the same angle α.

In the OBS system 200 according to invention, a tilt compensation is provided, to maintain the actual image at an attitude or tilt angle being stable with respect to the movement or tilt angle of the head gear 275. Thus, in case the vehicle 500 is at a yaw, roll or pitch angle different from the horizontal plane of the surrounding seen, the operator may tilt his head as he would be located outside the vehicle to compensate for the tilt angle or the vehicle, thereby simply by tilting his head in the operate direction would achieve an erect image as a natural image of the scene as the operator would always do when observing the scene directly without the camera of screen. In use, any case displayed in FIGS. 9 B and 9 C, when the operator's head is tilted an angle α to view an image tilted by a corresponding angle, the image would be rotated in the same angle within the image field 310 for providing an apparent compensation of the tilt angle that otherwise would be inconvenient to the operator of the OBS system 200 of the invention.

Reference is now made to FIGS. 10 A, B and C, for explaining the principal of the invention for plotting in three dimensions positions of interest in the image field displayed to the operator.

The three dimensional plotting of positions, and corresponding graphic overlaid symbols, is based on a three dimensional model (3D model). Referring first to FIG. 10 A, the vehicle 500 (that is, the location of the vehicle 500) is positioned in the three dimensional model with geographic positions plotted in various position as shown by the references 461. In an advantageous embodiment of the invention, all objects that represent positions of interest (visualized as “balls”) are of the same and fixed size. Accordingly, objects with positions that are far away will appear smaller than those located closer to the vehicle, thereby providing an indication of how far away the objects in fact are.

Reference is now made to FIG. 10 B, wherein the vehicle 500 is positioned in a three dimensional roll model. With the viewing direction of the sensor head 220 of the OBS system 200 of the invention corresponding to the heading direction of the vehicle 500, the current frustum as described earlier will then be located in the model space as illustrated by the pyramidical volume drawn in FIG. 10 B, and with the far plane texture of the video image viewing field indicated by referenced numeral 310. In the exemplary illustration of FIG. 10 B, only one object 461′ is located within the frustum to be drawn by an overlay graphic symbol, while other objects 461 and 461″ are outside the frustum and will not be drawn as graphic symbols appearing in image field 310.

Now, with reference to FIG. 10 C, a situation further corresponding to the situation illustrated in FIG. 10 B is depicted, wherein the during direction of the OBS sensor 220 is rotated by an angle counted clockwise with respect to the angle of viewing illustrated in FIG. 10 B, such that the object 461′″ is within the frustum and in the foreground with respect to the far plane to be imaged within the image filed 310 such that it will be represented by an overlay graphic symbol visible in the image field 310, whereas other objects 461, 461′ and 461″ are outside the frustum and will not be drawn for creating a corresponding graphical symbol in the overlay graphics.

By employing the method disclosed and explained with reference to FIGS. 10 A, 10 B and 10 C, the need for graphic processing capability is greatly reduced, while providing more processing capacity for excellent dynamics when drawing symbols for a highly dynamic image field 310. Thereby, rapid response in the drawing of graphic overlay symbols is provided, allowing the operator to move his head about quickly and to provide a smooth and rapid presentation of graphics overlaid symbols to follow the natural motion in the video projected as the texture in a limiting far plane of the frustum.

Reference is now made to FIG. 11, which provides a block schematic illustration of the principle of the arrangement of the invention for drawing video, the graphical overlay, and the three dimensional objects.

The video image is arriving from the camera or other source via the input IMG, and is projected on to a two dimensional sprite using the sprite function 281, for providing a two dimensional image 2DI. All data required to generate a two dimensional and a three dimensional overlay graphic are received in the data processor 282 as GPS data PCS for position, force and speed, such as data labelled VOR representing the vehicle orientation in terms of yaw, pitch and roll, observation sensor 220 angles labelled OBS in terms of azimuth and elevation, and RWS data labelled RWS representing RWS information in terms of azimuth, elevation and weapon range. Data process in the processor 282 are provided to the placing function 283 for placing a two dimensional overlay, and 3D placing function 285 for placing three dimensional objects. The 2D placing function 283 takes each single object found in the “list of 2D objects” 284, and places these objects in the image according to data that are considered valid.

The 3D placing function 285 takes each single object in the “list of 3D objects” 286, and places these objects in the image according to data that are considered valid. As output of the 2D placing function 283 is the two dimensional overlay 2DO, and as output of the 3D placing function 285 is the 3D objects 3DO. The two dimensional overlay and three dimensional objects are added to the two dimensional 2DI, and forwarded to the “rotate all” function 287, which is controlled by the head rotation (head tilt) angle α, in which rotation function 287 the image comprising all video, two dimensional and three dimensional objects are rotated by the rolled angle determined by the head tracker 276, according to the head tracker roll angle, to maintain the “horizon” in image as it would correspond to the real horizon determined by the operators tilt or roll of his head with reference to the base plane of the vehicle 500, or to the actual horizontal plane of the area in which the vehicle is operating.

1. A positionable sensor assembly for a real-time remote situation awareness apparatus, the sensor assembly comprising,
a camera arranged to capture an image of a scene,
a plurality of first acoustic transducers adapted to capture an audio input signal from an environment comprising said scene,
at least one second acoustic transducer excitable to emit an audio output signal,
a support structure arranged to support said camera, said plurality of first acoustic transducers and said at least one second acoustic transducer, said support structure connected to a base, moveably at least about an axis of rotation relative to said base by a support structure positioning actuator controllable from a remote location, and
a transmission means adapted to transfer in real-time between said transducer assembly and said remote location a captured image of said scene, a captured audio input signal from said environment, an excitation signal to said second acoustic transducer, and a control signal to said support structure positioning actuator.

2. The sensor assembly of claim 1, comprising a plurality of artificial ears including said first acoustic transducers and being adapted to pick up a binaural sound field at or around said sensor assembly so as to convey to an operator at said remote location a sense of direction to a source of said sound field relative to said support structure.

3. The sensor assembly of claim 1, comprising a plurality of artificial ear devices formed according to at least one of two ears of an individual, wherein
at least two of said plurality artificial ear devices including a respective one of said plurality of first transducers to provide directivity to said respective first transducer, and
said plurality of artificial ear devices being arranged on different parts of said support structure to receive at least part of said audio input signal arriving from said environment comprising said scene.

4. The sensor assembly of claim 2, wherein said plurality of artificial ear devices contains two artificial ear devices located on said support structure in positions corresponding to positions of said two ears of said individual.

5. The sensor assembly of claim 1, wherein the camera is a camera for capturing said image from light at wavelengths within the visual range of wavelengths or from light at wavelengths within an atmospheric transmission band for near infrared or far infrared wavelengths.

6. The sensor assembly of claim 1, wherein the camera includes two optical image sensors arranged to provide a said image of said scene as a stereoscopic image.

7. The sensor assembly of claim 1, comprising a fast servo controlled device adapted to control an orientation of said support structure relative to said base.

8. The sensor assembly of claim 1, comprising an image stabilizer means adapted to stabilize a said captured image of said scene by rapid movements of said support structure relative to said scene.

9. The sensor assembly of claim 1, wherein the second acoustic transducer is a directional acoustic transducer adapted to emit said audio output signal towards said scene.

10. The sensor assembly of claim 1, wherein said audio output signal is a voice signal.

11. A real-time remote situation awareness apparatus comprising the sensor assembly of claim 1, the real-time remote situation awareness apparatus further comprising
a direction sensor means adapted to determine a direction, relative to the base, of a line of vision of a human observer at said remote location and to output said direction to said transmission means as a control signal to the support structure positioning actuator, and
a presentation structure arranged to carry image and audio presentation devices in communication with said transmission means, said image and audio presentation devices adapted to render to said observer said captured image of said scene in said line of vision and said captured audio input signal in a direction of hearing of said observer.

12. The apparatus of claim 11, wherein
said presentation structure is a head wearable structure adapted to locate said audio presentation devices relative to a wearers head so as to provide a binaural sound reproduction enabling stimulation of a wearers natural response reaction to turn the head towards an apparent source of said sound.

13. The apparatus of claim 11, wherein
said presentation structure is a head wearable structure, and
said direction sensor means is adapted to determine the direction of the line of vision of the observer by determining an angular position relative to the base of the head wearable structure worn by the observer.

14. The apparatus of claim 11, further including a microphone in communication with the transmission means and arranged at said remote location to pick up a voice signal from the human observer and to output a signal adapted to cause the second acoustic transducer to emit said voice signal.

15. The apparatus of claim 1, the apparatus being linked to a mobile platform, and further including an optical pointing device, preferably a laser beam transmitter, positioned adjacent to at least one camera and aligned so as to emit a beam of light on command from the operator, and the apparatus having a position data output adapted to transfer position data of the sensor assembly to a fire control director of a remote weapon system RWS linked to said platform.

16. The apparatus of claim 1, the apparatus being linked to a mobile platform, and the apparatus having a position data input adapted to receive position data of a fire control director of a remote weapon system RWS linked to said platform, and adapted to render on an operator display an indication of a target or a position of a target at which the RWS weapon is being aimed.

17. A reconnaissance or combat vehicle including the sensor assembly of claim 1, the vehicle comprising a body having an interior space, wherein the base is affixed to or constituted by the body, and the remote location is at least in part in the interior space of the vehicle.

18. A reconnaissance or combat vehicle including the apparatus of claim 11, the vehicle comprising a body having an interior space, wherein the base is affixed to or constituted by the body, and the remote location is at least in part in the interior space of the vehicle.

19. The sensor assembly of claim 3, wherein said plurality of artificial ear devices contains two artificial ear devices located on said support structure in positions corresponding to positions of said two ears of said individual.

20. The apparatus of claim 12, further including a microphone in communication with the transmission means and arranged at said remote location to pick up a voice signal from the human observer and to output a signal adapted to cause the second acoustic transducer to emit said voice signal.
